(19) United States
(12) Patent Application Publication
(10) Pub. No.: US 2017/0313221 A1
(43) Pub. Date: Nov. 2, 2017

(54) Motor Vehicle Seat Head Support System

(71) Applicant: James Cormier, Ashburnham, MA (US)

(72) Inventor: James Cormier, Ashburnham, MA (US)

(21) Appl. No.: 15/481,925

(22) Filed: Apr. 7, 2017

Related U.S. Application Data
(60) Provisional application No. 62/319,898, filed on Apr. 8, 2016.

(51) Int. Cl. B60N 2/48; B60N 2/26

(52) U.S. Cl. CPC B60N 2/4882; B60N 2/26; B60N 2/4879

(57) ABSTRACT

A head support system for a seat of a motor vehicle, with a strap system that is constructed and arranged to be coupled to the motor vehicle such that a strap portion is located along two sides the seat, proximate the expected location of the head of a person sitting in the seat, and a pair of head cushions, one of the head cushions coupled to each of the strap portions.

### CROSS-REFERENCE TO RELATED APPLICATION

This application claims priority to Provisional application 62/319,898, filed on Apr. 8, 2016, the entire disclosure of which is incorporated herein by reference.

### BACKGROUND

This disclosure relates to a head support system that can be attached to a seat of a motor vehicle.

When children fall asleep in an automobile while in a booster seat (or not in a booster seat), often times they are unable to hold their heads up and their heads and neck either fall forward or off to one side. Their necks get cranked off to one side and with every bump in the road their necks get even more stressed. Holding the spine in extreme postures out of alignment can adversely affect the health of the spine and, subsequently, the health of the individual. Improper neck posture can lead to spinal misalignments, muscle and ligament strains, neck pain, and headaches.

### SUMMARY

Just like proper ergonomics are preached for the office worker, for sitting and standing without slouching, optimal sitting ergonomics in the automobile are equally important. The subject support system helps to maintain proper ergonomics/posture while riding in an automobile. The support system helps maintain proper posture, while keeping the spine in a healthy, supportive position.

The support system helps to support the neck and spine in a neutral position helping to avoid the stress and strain that poor posture in the automobile could place on the child's neck and spine structures. The support system helps give the child a safe, comfortable, enjoyable ride without the neck strain. The support system helps to protect against spinal misalignment which can lead to neck pain, headaches and even ear symptoms in children. It is also designed to protect the delicate nerve tissue in the neck from interference and stress.

All examples and features mentioned below can be combined in any technically possible way.

In one aspect, a head support system for a seat of a motor vehicle includes a strap system that is constructed and arranged to be coupled to the motor vehicle such that a strap portion is located along two sides the seat, proximate the expected location of the head of a person sitting in the seat, and a pair of head cushions, one of the head cushions coupled to each of the strap portions.

Embodiments may include one of the following features, or any combination thereof. The head cushions may be arranged to be removably attached to a strap portion. The attachment of the head cushions to the strap portions may be accomplished using a hook and loop-type mechanical fastening system on the strap and a side of the head cushions. The head cushions may each be adjustable along a length of a strap portion, and along a width of the head cushion

Embodiments may include one of the following features, or any combination thereof. The strap system may comprise a single strap with connectors at two opposed ends of the strap. The connectors may be snap hooks, and the snap hooks may be constructed and arranged to be coupled to a latch anchor. The strap may run behind a headrest of the seat. The headrest may comprise support posts, and the strap may run behind the support posts. The length of the strap and its tightness may be adjustable through a mechanical device. The mechanical device may comprise a cam-adjustment device. The cam-adjustment device may be located behind the headrest support posts, or it may be located along a strap portion that is between a head cushion and a seat bottom cushion.

In another aspect, a head support system that is constructed and arranged to be coupled to a seat of an automobile includes a strap with two ends, with a strap connector at each end that allows the strap to be coupled to and removed from car seat latch anchors, where the strap runs behind a seat headrest, and where a length of the strap and its tightness is adjustable through a mechanical device, and a pair of cushions that are constructed and arranged to be removably attached to the strap. The attachment of the cushions to the strap may be accomplished using a hook and loop-type mechanical fastening system on the strap and a back face of the cushions. The strap connectors may be snap hooks.

### BRIEF DESCRIPTION OF THE DRAWINGS

FIG. 1 is front perspective view of an example of a motor vehicle seat head support system.

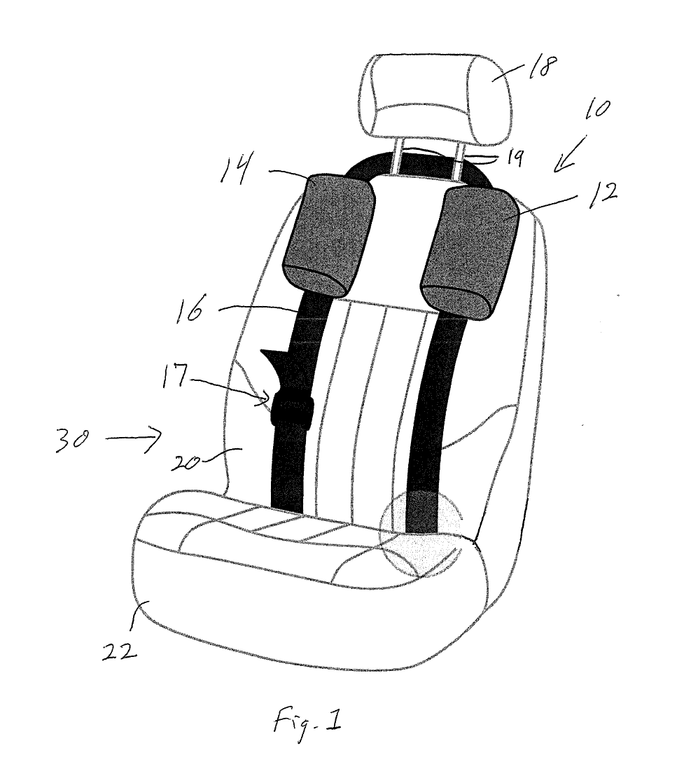

FIG. 2 is a partial, close-up view of an anchoring for the system of FIG. 1

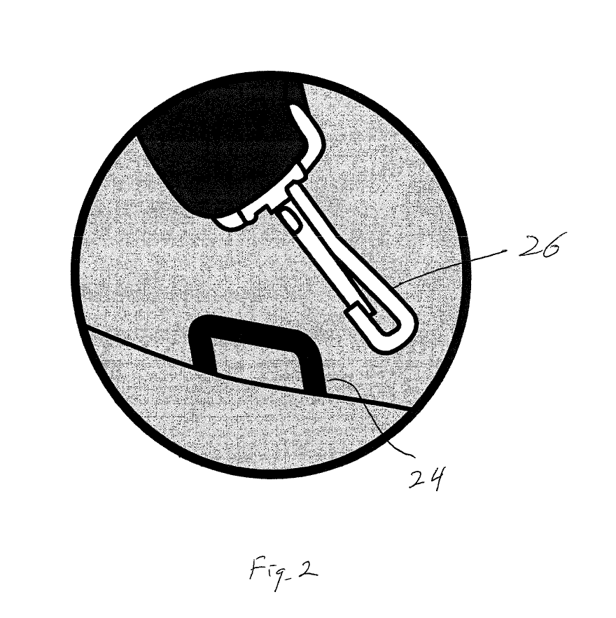

FIG. 3 is a partial, side, disassembled view of a strap and cushion, of the system of FIGS. 1 and 2.

### DETAILED DESCRIPTION

The motor vehicle seat head support system is constructed and arranged to place cushions on both sides of the head of a person sitting in the seat of an automobile. The cushions help to inhibit the head and neck from maintaining an awkward, bent position if the person falls asleep. In one non-limiting example, the system includes a strap that is constructed and arranged to be removably coupled to the seat such that strap portions are located along at least part of the height of the seat, on both sides of the location of the head. A head cushion is carried by each strap portion. The head cushions help inhibit the head from falling off to the side and/or forward. To make the system applicable to persons of different size and shape, the locations of the head cushions is adjustable along at least part of the length of the two strap portions.

One non-limiting example of the subject head support system 10 is shown in the drawings. System 10 includes strap 16 that has snap hooks 26 on both ends, so that it can be clipped to and removed from the car seat latch anchors 24; latch anchors 24 are located at the junction of the seat back 20 and the seat bottom cushion 22 of motor vehicle seat 30, and are part of LATCH-equipped child safety seats. Strap 16 runs behind the support posts/extenders 19 that are part of headrest 18. The length of strap 16 and its tightness can be made adjustable through an optional mechanical means, such as the cam-adjustment device 17 or another type of strap length/tightness adjustment device now known, or developed in the future.

Head cushions 12 and 14 are preferably removably attachable to strap 16 at different heights from seat bottom cushion 22, to accommodate children/people of different heights. This attachment is preferably but not necessarily accomplished using a hook and loop-type mechanical fastening system on the strap and the backs of the head cushions. Alternatively, the head cushions can be fixed to the strap lengths and extend along enough of the lengths of the two strap portions on either side of the person, such that they will support the head of most people.

The support system can be made from soft and comfortable PVC free materials, natural latex foam, and can be free from harmful chemicals. The head cushions cradle the head supportively on both sides. The system is easy to install and use, easy to clean, adjust for different sized children, and fits most automobiles with car seat attachments and rear head rest supports. It is easy to store in the trunk for quick access, and it is especially helpful to use for long extended periods of car travel.

The head cushions 12 and 14 can be (but need not be) made of high density natural latex foam because latex is a soft comfortable yet firm and supportive natural product with no harmful chemicals. In one non-limiting example, the head cushions are 4 inches at the base, 6 inches in length (bottom/shoulder to top/top of head) and 5 inches tall (back to front). This area gives the head cushions enough support and contact area to support the head and neck comfortably and securely. The rear side of the head cushions can be backed with a 4″ wide×6″ length hook (Velcro like) material for ample adjustment of the side-to-side placement, to accommodate narrow sized heads and larger, wider heads. The fitting of the support system is custom and not a fixed size like the C-collar type of neck cushion. System 10 is in one non-limiting example designed strictly to be used in the back seat of an automobile for children or very small petite adults. The hook and loop (Velcro like) material allows for a secure stationary fit with the ability to make up-down and side-to-side position changes to the head cushions for an optimal custom fit.

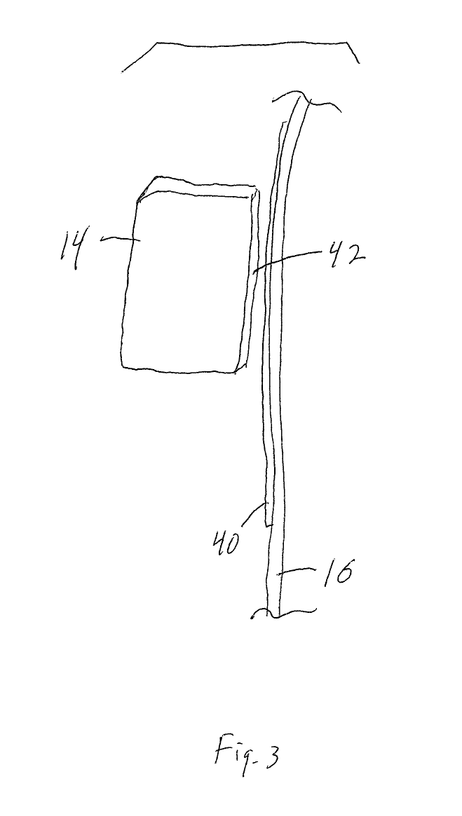

FIG. 3 illustrates hook and loop-based removable fastening of head cushion 14 to strap 16. Back face 42 of head cushion 14 can carry hook-type (or loop-type) fastener material. Strap 16 can, at least along portion 40, carry loop-type (or hook-type) fastener material. This allows head cushion 14 to be coupled to strap 16 virtually anywhere along the height (length) of strap portion 40, and at varying width locations of the head cushions.

The (optional) use of snap hooks or latches allows quick and secure attachment to the car seat attachments (latch anchors). A earn allows quick adjustments and the ability to tighten the 2″ strap webbing securely into place. The cam 17 or other strap adjustment means can alternatively be located on the portion of strap 16 that is behind the headrest support posts. At least 12 inches of loop (soft Velcro like loop material) sewn into both sides of the webbing of the strap allows for a full spectrum of custom head cushion height placement to ensure proper height fit for all sized passengers with the ability to have endless changes to the placement of the cushions to ensure a long usefulness of this product with a growing family.

The support system attaches directly and securely to the car seat attachments and the rear head rest, making it a very secure connection. The support system comfortably limits the side to side motion of the neck and spine helping to anchor and support the rest of the spine/body to stay in alignment as well. The support system is appropriate for ages and sizes from platform booster seat use to middle school if not high school depending on height of child.

The support system contact points of the head cushions are on the side of the head which limit the ability of the head to side tilt. In children, the ratio between the weight and size of the head compared to the size and strength of the neck is large and is an important factor and the reason children have trouble holding their heads up. It isn't until later when the child becomes much bigger and the muscular development of the neck occurs that they are able to hold up the head better.

A number of implementations have been described. Nevertheless, it will be understood that additional modifications may be made without departing from the scope of the inventive concepts described herein, and, accordingly, other embodiments are within the scope of the following claims. For example, there could be two separate strap portions, one on each side of the expected location of the head. The one or two strap portions can be coupled to the motor vehicle (preferably, but not necessarily, the seat) in any mechanical manner that results in portions of the strap(s) located along both sides of the head. The strap(s) can have an adjustable length/tightness, or not. Such adjustment can be accomplished in any convenient manner. The cushions could be fixed to the strap portions, or can be removably coupled to the strap, as shown, and as described above.

What is claimed is:

1. A head support system for a seat of a motor vehicle, comprising:
a strap system that is constructed and arranged to be coupled to the motor vehicle such that a strap portion is located along two sides the seat, proximate the expected location of the head of a person sitting in the seat; and
a pair of head cushions, one of the head cushions coupled to each of the strap portions.

2. The head support system of claim 1, wherein the head cushions are arranged to be removably attached to a strap portion.

3. The head support system of claim 2, wherein the attachment of the head cushions to the strap portions is accomplished using a hook and loop-type mechanical fastening system on the strap and a side of the head cushions.

4. The head support system of claim 1, wherein the head cushions are each adjustable along a length of a strap portion, and along a width of the head cushion.

5. The head support system of claim 1, wherein the strap system comprises a single strap with connectors at two opposed ends of the strap.

6. The head support system of claim 5, wherein the connectors comprise snap hooks.

7. The head support system of claim 5, wherein the snap hooks are constructed and arranged to be coupled to a latch anchor.

8. The head support system of claim 6, wherein the strap runs behind a headrest of the seat.

9. The head support system of claim 8, wherein the headrest comprises support posts, and wherein the strap runs behind the support posts.

10. The head support system of claim 5, wherein a length of the strap and its tightness is adjustable through a mechanical device.

11. The head support system of claim 10, wherein the mechanical device comprises a cam-adjustment device.

12. The head support system of claim 11, wherein the headrest comprises support posts, and wherein the cam-adjustment device is located behind the headrest support posts.

13. The head support system of claim 11, wherein the cam-adjustment device is located along a strap portion that is between a head cushion and a seat bottom cushion.

14. A head support system that is constructed and arranged to be coupled to a seat of an automobile, comprising:
a strap with two ends, with a strap connector at each end that allows the strap to be coupled to and removed from car seat latch anchors, where the strap runs behind a seat headrest, and where a length of the strap and its tightness is adjustable through a mechanical device; and
a pair of cushions that are constructed and arranged to be removably attached to the strap.

15. The head support system of claim 14, wherein the attachment of the cushions to the strap is accomplished using a hook and loop-type mechanical fastening system on the strap and a back face of the cushions.

16. The head support system of claim 15, wherein the strap connectors comprise snap hooks.
